(19) United States
(12) Patent Application Publication
(10) Pub. No.: US 2013/0151003 A1
(43) Pub. Date: Jun. 13, 2013

(54) METHODS AND SYSTEMS FOR CLASS-FLEXIBLE DRUG DISPENSING AND ELECTRONIC BILLING

(71) Applicant: RANDOLPH ROYAL GILLUM, MESQUITE, TX (US)

(72) Inventor: RANDOLPH ROYAL GILLUM, MESQUITE, TX (US)

(21) Appl. No.: 13/313,386

(22) Filed: Dec. 7, 2011

(51) Int. Cl. G06Q 50/22; G06Q 30/04; G06F 7/00

(52) U.S. Cl. 700/216; 705/2

(57) ABSTRACT

Presented are automated “class-flexible” drug dispensing systems, which include an automated drug dispensing machine. The automated machine has a multiplicity of drug cartridges and dispenses appropriate drugs on command from cartridges to fill a prescription. The system also has a user interface to input prescription information and class of trade information for each particular prescription to be filled. Further, it has an electronic storage medium with drug identifying information for the drug in each of the multiplicity of cartridges and the inventory of the drug in each cartridge. In addition, the system includes an electronic billing system that includes prescription information and the drug “class of trade” information. The billing system uses this information to create an electronic billing entry. Also presented are drug distribution systems to reduce overall drug costs from manufacturer to end user.

### BACKGROUND

1. Field of the Invention

The technology relates to methods and systems for use in the automated dispensing and electronic billing of prescription medications, regardless of whether in a hospital, long term care facility, retail location, or retail pharmacy. More particularly, the automated dispensing protocol is flexible as to “class of trade” and includes information regarding the class of trade of the particular prescription medication being dispensed for appropriate electronic billing.

2. Description of the Related Art

In the United States, the dispensing and pricing of prescription medications (“drugs”) is closely controlled both by the government as well as institutions in an effort to achieve a number of goals. Some of these goals include maintaining control of “controlled substances,” reducing costs, and ensuring appropriate prescriptions (i.e. reducing the risk of drug interactions, ensuring proper dosage at the appropriate time, etc.).

Despite the institutional structures in place, there is widespread and significant “waste” of medications due to practices common in the health care field. In addition, there are also inefficiencies “built in” to the systems that result in higher overall health care costs.

As a preliminary matter, and to more fully appreciate the reasons for this, it should be noted that there are essentially three classes of trade for prescription medications: hospital, long term care (LTC) and retail. The pricing of the same medication varies depending upon the class of trade it is in. For example, a drug may have a first price in the hospital class of trade that is less than pricing in each of the LTC and retail classes of trade. Accordingly, a person who uses a particular drug will be billed a different price depending upon whether he/she obtained the drug while staying in a hospital, or in a LTC, or obtained it from a retail pharmacy. In addition, in most facilities such LTC facilities, drugs for a particular patient are pre-dispensed into, 30-day blister packs, or other similar containers, that provide the prescribed daily dose(s) for the patient for a period of a month. However, a patient may have a much shorter stay in a facility, for example, 3 days. The unused 27 days of prescribed drugs is then discarded (as “waste”) posing safe disposal issues. The discharged patient, in most cases, will be provided with a prescription for ongoing drug use, to be filled at a retail pharmacy. The hospital may not provide these post-hospital care drugs because once the patient is discharged, he/she is outside of the hospital class of trade. And so, any further drugs must be obtained in the differently-priced retail class of trade, or LTC class of trade, if the patient is discharged to such a facility.

It is also well-known that there is a significant degree of “non-compliance” among discharged hospital patients in terms of continuing to take their prescribed medications in the appropriate doses and at the times prescribed. There are many reasons for non-compliance, and drug cost to the patient in the retail sector may be a factor. Regardless of the reason, such non-compliance often leads to patient relapse and re-admittance to a hospital. This re-admittance causes additional costs for uncompensated treatment (it is not covered by Medicare, for example) of the relapsed patient that the hospital has to bear, if the re-admittance is within the “window” of time set by the “diagnosis related group” (“DRG”) for the medical condition for which he/she was previously treated, and discharged from the hospital. Accordingly, while hospitals may have a great deal of incentive to provide some “take home medications” to a discharged patient to avoid the risk of a costly uncompensated re-admittance of the patient due to his/her non-compliance; hospitals cannot do so due to the class of trade restraints that apply to prescription drugs. Hospitals may only provide medications to patients that have in-patient status at their facility.

In more recent years, steps have been taken to reduce errors and to speed up the accurate dispensing of drugs. These steps often involve the use of automated drug dispensing machines. Such machines contain cartridges of a wide selection of commonly prescribed drugs. When drugs are needed for a particular patient, information is input to the automated dispensing machine via a graphic user interface or other interface and the machine quickly and accurately dispenses the drugs. Drugs may be dispensed, for example, in sealed packets such as packets in plastic or cellophane strips that are imprinted with necessary information, such as patient identification, drug identification, dosage, time of administration, etc. In some facilities, such as hospitals, LTC facilities, or retail pharmacies, the automated dispensing machines may be linked to billing systems to assist in automated electronic billing of patients. However, these machines are, of course, restricted by class of trade. Thus, for example, an automated dispensing machine in a hospital dispenses drugs and may bill using pricing set for the hospital class of trade, while one in a retail pharmacy will use retail class of trade pricing.

The current distribution system for prescription medications follows a particular and costly path. Manufactured drugs, those in solid form (tablet, capsule, etc.), which make up the bulk of the drugs, are typically bottled in quantities of relatively small fixed amounts and each bottle has a package label insert, as required. The usual bottle holds small amounts such as 100 or 30 drugs, depending upon a variety of factors. Each bottle is sealed with a tamper proof seal, as required. The bottles are then packed into cartons and shipped directly to pharmacies or to a wholesale warehouse. Retail pharmacies and facilities such as hospitals and LTC facilities buy drugs from these wholesale warehouses. Some organizations related to these pharmacies or wholesalers may have obtained a “re-packaging license,” and may re-package pills from the manufacturer's (or other repackager's) containers into smaller pill quantity containers, for example. Retailers buy from wholesalers and or manufacturers, and when a sealed bottle is received at a pharmacy in the retail trade, and a prescription is presented, extensive manual operations commence. The tamper proof seal is broken as the bottle is manually opened, and the requisite amount of pills are counted out manually, placed into a new bottle, a new label is printed out, and the new bottle is labeled appropriately.

### SUMMARY

Exemplary embodiments include automated class-flexible drug dispensing systems, which include an automated drug dispensing machine. The automated drug dispensing machine has a multiplicity of drug cartridges and it dispenses appropriate drugs on command from one or more cartridges to fill a prescription. The system also has an interface to input prescription information and to input class of trade information for each particular prescription to be filled. Further, it has at least one electronic storage medium having drug identifying information for the drug in each of the multiplicity of cartridges and for maintaining an inventory of the drug in each cartridge. In addition, the system includes an electronic billing system that receives the input prescription information and the input class of trade information. The billing system uses the prescription information and the class of trade information to create an electronic billing entry. In an exemplary embodiment, the automated drug dispensing machine may be associated with a hospital pharmacy. In that event, the billing system may be configured to apply pricing for a hospital class of trade by default. In a further example, the system may include an interface receiving electronically transmitted input information from a remote monitor-dispenser of a discharged patient (or LTC resident away from the LTC facility for a period of time) about patient (or resident) compliance with prescribed drug administration. The system may further electronically and automatically transmit information to the discharged patient (or LTC resident) in response to received input information about his/her compliance with prescribed drug administration. In a further optional exemplary embodiment, the system may include storing electronic patient health data in a database and data mining the database.

Another exemplary embodiment provides methods of automatically filling a prescription for specified medications. The method includes the step of receiving electronic prescription information. Further, the method uses the received electronic prescription information to command an automated drug dispensing machine to select and package the prescribed drugs. In addition the method includes the steps of electronically receiving class of trade information about the prescription; and determining a price for each drug of the prescription based on the drug and the received class of trade. The method then creates an appropriate electronic billing entry.

A further exemplary embodiment provides methods for minimizing the cost of processing prescription drugs in a distribution system extending from a manufacturer to an end user. The exemplary method includes contracting to receive prescription medications in bulk packs directly from a drug manufacturer. Further, it includes arranging for repackaging of the bulk pack prescription medications into cartridges adapted for use in automated drug dispensing machines, and supplying the cartridges filled with re-packaged prescription medications to a party having control over drug dispensing machines. In addition it includes facilitating the use of the cartridges of repackaged prescription medications in a class flexible drug dispensing system linked an electronic billing system.

A yet further exemplary embodiment presents a drug distribution system extending from a manufacturer to an end user that minimizes the cost of processing prescription drugs. The system includes the steps of contracting to receive prescription medications from a drug manufacturer or wholesaler or other source, in cartridges adapted for use in automated drug dispensing machines; supplying the cartridges filled with prescription medications to a party having control over drug dispensing machines; and facilitating the use of the cartridges of prescription medications in a class-flexible drug dispensing system linked an electronic billing system.

### BRIEF DESCRIPTION OF THE DRAWINGS

The following drawings are not to scale and are provided for ease of explanation. The Figures depict exemplary embodiments, and do not limit the scope of the invention, as defined in the patent claims, here below:

FIG. 1 is an illustration of an overview of a prior art system including an automated drug dispensing machine linked to an electronic billing system;

FIG. 2 is an illustration of an example of a cartridge used in a prior art automated drug dispensing machine;

FIG. 3 is an illustration of an exemplary embodiment of class-flexible drug dispensing and electronic billing system including an automated drug dispensing machine in communication with an electronic billing system;

FIGS. 4-6 are exemplary systems for reduced cost drug distribution from the manufacturer to the patient; and

FIG. 7 depicts an exemplary embodiment of a patient non-compliance alert and remediation system.

### DETAILED DESCRIPTION

In the specification and claims, the terms “prescription medication” and “drug” or “prescription drug” are interchangeable and refer to legal pharmaceuticals prescribed by a health care professional.

In the specification and claims, the term “class-flexible” relating to the methods, devices and systems of the technology presented means that the methods, devices and systems operate without being limited to any one class of trade but are capable of operating and do operate within multiple classes of trade. While there are at present three classes of trade, regulations in future may create more such classes. Accordingly, class-flexibility means having flexibility to select between classes whenever there is more than one class, regardless of whether there are two, three, or more classes.

In the specification and claims, the term “prescription information” means information relevant to a prescription for a medication, and some or all of it may be in coded form, such as serial numbers, bar codes or other machine-readable coding formats. Prescription information” may include subsets of information, for example including but not limited to “patient identification information,” “drug identifying information,” and “prescription billing information.” Examples of “prescription information” may include some or all of the items in the following non-exclusive listing: drug name, manufacture, wholesaler identification, lot number, expiry date, patient name, patient date of birth, patient account number, patient location information (if in hospital or LTC facility, for example), prescription identifying number, drug administration information for the nurse or other health care provider (e.g. mg/day, quantity of particular pills per day or per administered time, and number of times per day to administer drugs), time to administer a dose to the patient, identifying and contact information for attending physician, identifying and contact information for prescribing physician dispensing pharmacy identifying information, class of trade in which dispensing is taking place, payer source identification, wholesaler identification, accountable care organization identification, etc. All information input into the systems described herein may be in any format receivable by the system hardware, such as for example, hand-written alpha numeric, printed alpha numeric, or machine readable.

In the specification and claims, the term “bulk packs” refer to pill (tablet or capsule) containers having quantities of pills that exceed the current standard, such as the 100 or 30 pill bottles, by a factor of at least about 4 and in some examples about 10 or more, depending upon the economic optimum size, which depends on demand, inventory carrying costs, inventory replenishing costs, and other factors. The term “bulk packs’ includes the possibility that the pills are loaded into a cartridge adapted for use in an automated drug dispensing machine.

In the specification and claims, the term “cartridge,” is used to refer to a pill container adapted to be used in an automated drug dispensing machine, and is not limited by any physical structure or shape but encompasses any container adapted for use in an automated drug dispensing machine that can hold a multiplicity of cartridges and can dispense a multiplicity of drugs on command.

In the specification and claims, the term “bottle” referring to a container for pills, means a tamper-proof, sealed container of pills that is not susceptible to being used in an automated drug dispensing machine.

In the specification, the term “exemplary embodiment” means an example of an embodiment of the technology that is the subject matter of at least some of the patent claims. Examples presented are illustrative and do not limit the scope of the claimed subject matter.

In the specification and claims, the term “drug kiosk” refers to a free-standing automated drug dispensing machine able to dispense drugs upon receipt of input of proper prescription information (in written, printed or machine readable form) and that has a communications link to a system able to verify the prescription information. Reference in the specification to retail pharmacies should, in appropriate contexts, be read broadly to include drug kiosks.

In the specification and claims, the term “patient compliance monitor-dispenser” means a device with software that is programmed with some prescription information about patient drug administration (at least including the prescribed times when a dose has to be taken), that dispenses drugs to a patient when prompted, and that transmits an electronic alert, preferably via the Internet or telephony, to a facility or care giver, as appropriate, when the patient has not accessed a scheduled drug dose.

A published PCT Application, International Number PCT US11/32150 filed on Apr. 12, 2010, published on Oct. 13, 2011 as PCT Publication Number 2011/0251850, and entitled “On Site Prescription Management Systems and Methods for Health Care Facilities,” is fully incorporated by reference herein, including both text and drawings.

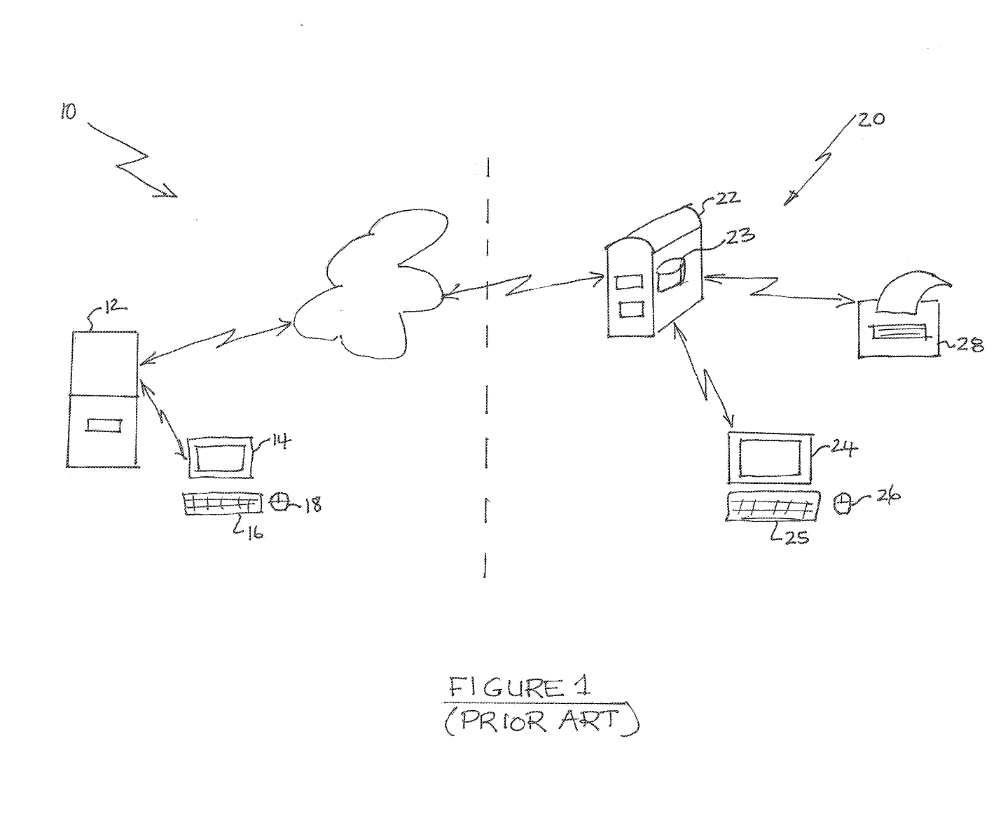

As a preliminary matter, there are prior art systems that include automated drug dispensing machines that are linked to billing systems. An example of such a system 10 is shown in FIG. 1. An automated drug dispensing machine 12 is linked to a user interface illustrated as a monitor 14, a keyboard 16 and a mouse 18 for input of the prescription, which does NOT include the class of trade. The class of trade is fixed depending upon where the automated drug dispensing machine is located. Upon user input of the prescription, the automated drug dispensing machine 12 dispenses the drugs, often in a strip containing individual packets, each having the required pills to be administered at a particular time. The strip typically contains multiple packets and may in a single operation provide doses for a period of 30 days for a particular patient. The packets on the strips include information printed thereon, and the information may include at least some in the following non-exclusive list: patient identifying information, drug identifying information, physician identifying information, and drug administration information. Information about the dispensed drugs is communicated electronically to a billing system, via the Internet in the example shown. The example of the billing system 20 illustrated includes a computer 22 with a storage medium (memory) 23 and software configured to calculate a billing entry for the dispensed drugs. The software is set up to select pricing of drugs stored in memory 23 in accordance with the facility in which the automated drug dispensing machine operates. Thus, if the drug dispensing machine is in a hospital, only those prices relating to the hospital class of trade are used. Similarly, if the automated drug dispensing is in a LTC facility, only pricing of the LTC class of trade is used, and if in the retail sector, only retail class of trade pricing is used. The illustrated billing system 20 includes a user interface having a visual monitor 24 to review billing entries, a keyboard 25, and a mouse 26 to edit billing entries, as well as a printer 28 to print out billing entries, as needed.

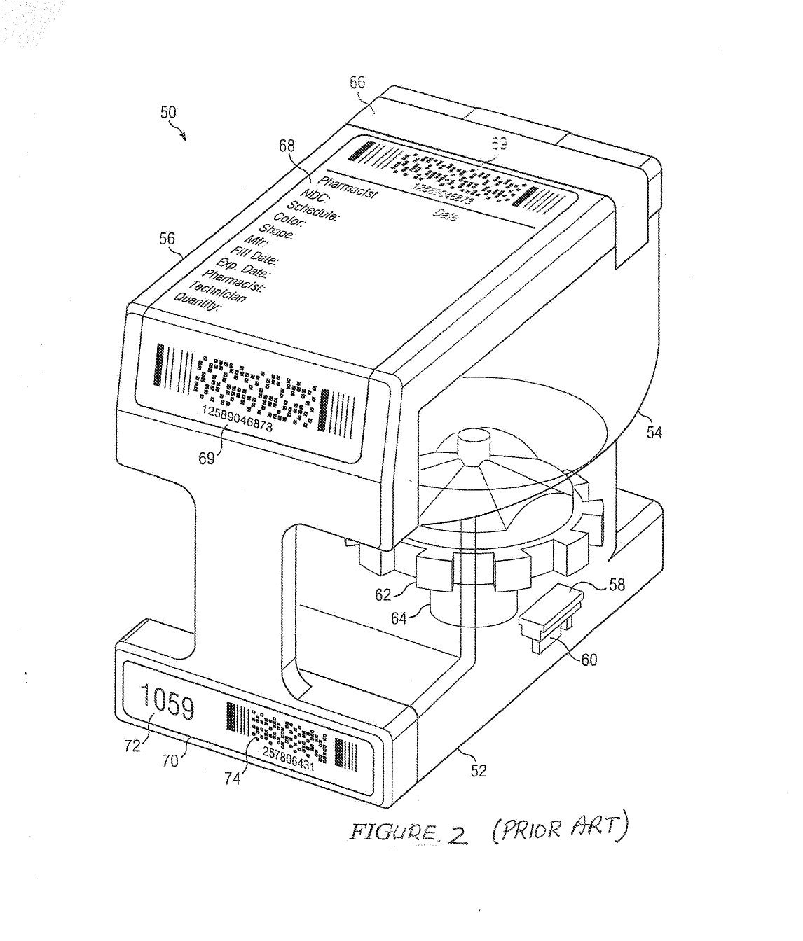

An exemplary prior art cartridge used in an automated drug dispensing machine that contains a multiplicity of such cartridges each containing pills of a drug, is illustrated in FIG. 2. The exemplary cartridge 50 may be fabricated with a body 52 of clear plastic to permit an additional visual check of the loaded drugs, which are frequently colored by medication and dose strength (mg.). The cartridge 50 includes a transparent hopper section 54, a lid 56 having a sealing tape 66. It also includes a memory holder 58 that holds a memory chip 60. Further, the cartridge 50 has a toothed division block 62, coupled to a drive hub 64, which is indexed such that it rotates one index position to another (i.e. from one tooth to the next allowing a pill to pass through the gap in between) to distribute a single pill. Rotational force for the hub 64 is provided by the automatic dispensing machine into which the cartridge 50 is mounted. As shown the cartridge 50 may have includes a “fill label” 68 that includes at least some prescription information printed in machine readable format, as well as in alpha numeric print, as an added safeguard. The cartridge may also have a “build label” 70 that identifies the cartridge uniquely. This may assist in cartridge tracking during fill operations, during transit, and in the field. Scanning of this information may be used to cross reference with a database that has a record of its contents, at each stage. The memory chip 60 interfaces with electronics of an automated dispensing machine such the machine is able to determine precisely where the cartridge 50 is located within the machine, and is therefore able to activate its drive units to rotate the hub 64 of the cartridge to dispense pills, as appropriate. Since the automated drug dispensing machine is able to read information from the memory chip 60, and the system can store this information, the system would have a record of the initial fill of the cartridge and all other prescription information in the memory chip 60. The system can then readily update inventory within cartridge 50, as the automated drug dispensing machine of the system fills prescriptions from the cartridge 50.

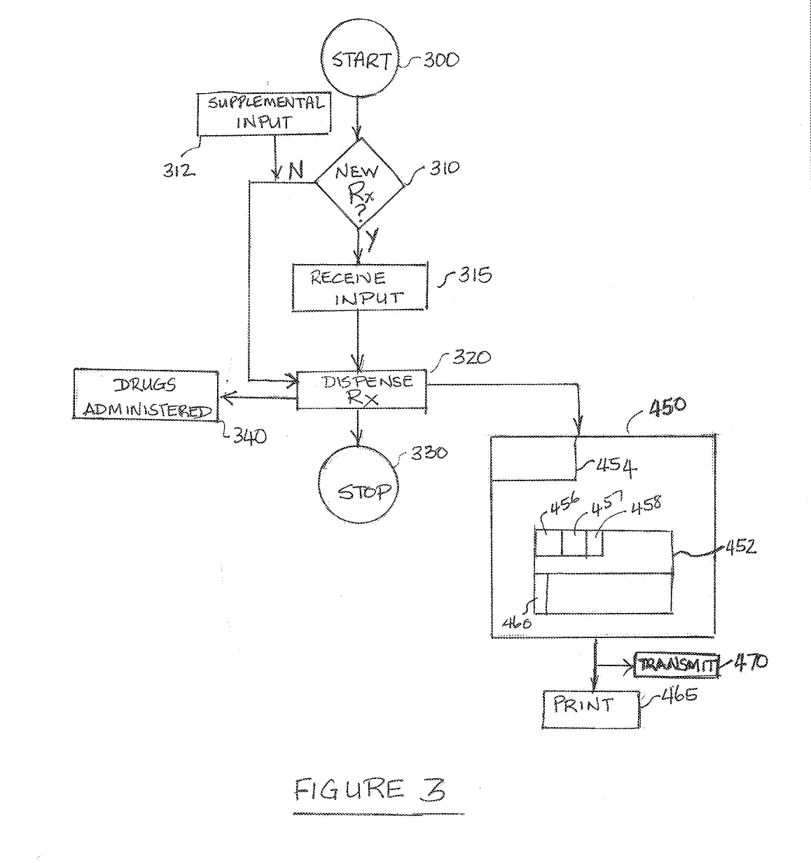

FIG. 3 is a flow chart illustrating an overview of the steps of an exemplary embodiment of a method or system used in class-flexible automated drug dispensing and billing. As shown, the method is initiated at start 300. The system queries whether it is about to fill a new prescription or an existing one at step 310. If it is a new prescription, the system proceeds to receiving input information at step 315. The input information includes “prescription information, as defined above, which includes class of trade information. A default may be set so that when the automated drug dispensing is in a hospital, for example, the default will be the hospital class of trade. But, that default may be over ridden by a specific input of the retail or LTC class of trade for example, if the drugs are for a discharged patient going home or to a LTC facility, as appropriate. Similar overrides may be used for automated drug dispensing machines located in the retail pharmacies, or locations including, but not limited to, LTC facilities. The automated drug dispensing machine at step 320 selects the appropriate cartridge(s) and dispenses the quantities of pills prescribed. In step 320 the automated drug dispensing machine presents the drugs in a sealed packet with labeling reflecting selected prescription information, as well as drug administration information. To minimize waste, the system controls (software) may can be configured to limit the automated drug dispensing machine to supply only a daily prescription amount, or an amount sufficient for a single administered dose (there may be multiple doses administered per day) or a multiple day supply. The system controls may be set as a default value that may be over ridden by the user through the user interface. Upon dispensing the drugs, the automated drug dispensing machine ends 330 the operation and is available to receive new inputs of prescription information from the user interface at step 310. The dispensed drugs are administered per the prescription at step 340.

If the system is instructed at step 310 that the prescription to be filled is not new, it proceeds to step 320 to fill the prescription, after receiving supplemental input at step 312. This supplemental input may include, for example, patient identifying information, prescription identifying information (e.g. prescription number) and the number of doses or days of supply that must be dispensed.

In the illustrated flow chart, information (including input prescription information and billing information) is relayed electronically to the electronic billing system 450 upon dispensing the drugs. Of course, that information may be transmitted at any time after or upon entry at the user interface. The billing system includes a memory 452 for data storage, and a CPU 454 to perform functions including executing billing software programs. In the billing system an algorithm selects the appropriate charge for the filled prescription. This charge is based on the default class of trade or the override input class of trade (as explained above), which determines drug prices to be charged to the user. This selection may be carried out by using look up tables 456, 457 and 458 that tabulate the drug's identity and the drug's price in each class of trade. Since this class of trade pricing information is stored in a data base, it may be readily updated or reported back to the wholesaler or manufacturer for purposes of re-pricing or allocating the dispensed drug to the appropriate class of trade. The electronic billing system also uses patient insurance information (for example, insurance company and drug plan, Medicare, Medicaid) to prepare and store an appropriate billing entry 460 for the patient and for the other entity (insurance company, Medicare or Medicaid). The billing entry may be printed out either as an entry or as part of a bill, in step 465. It may also be transmitted as electronic billing information in step 470.

The foregoing addresses a significant issue facing hospitals: the issue of patient non-compliance on discharge and the hospital's potential for uncompensated re-admission with the DRG window. The hospital, having the capability provided by a flexible-class automated drug dispensing and billing system, is able to provide drugs to a discharged patient in the retail class of trade if he/she is going home, or in the LTC class of trade if he/she is going to a LTC or skilled nursing facility (SNF). Moreover, it also addresses the issue of drug wastage that results from multi-day packaging such as blister packs or vials that are discarded after only a few days drugs have been consumed. The system user may now input the number of dosage packets to prepare at any one time: a single dose to administer, a daily prescribed number of doses, or a multi-day supply.

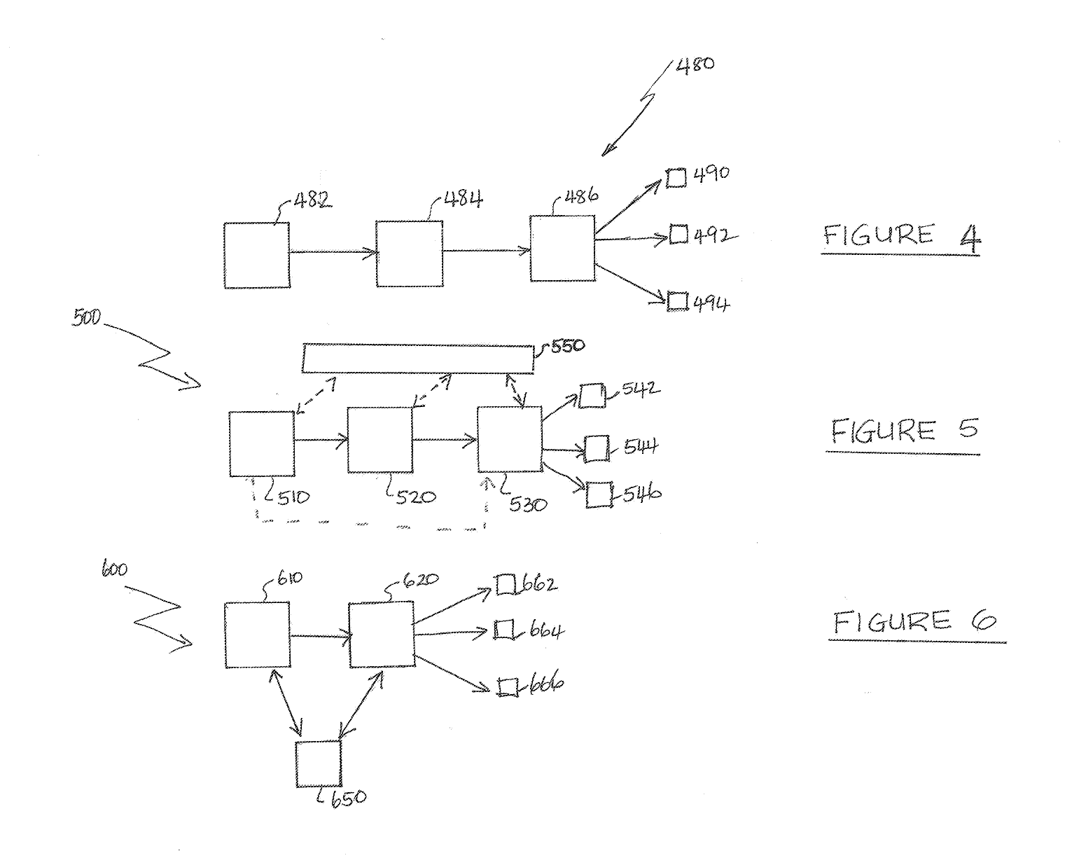

Further cost reductions are possible through use of the exemplary embodiments of distribution methods illustrated in FIGS. 4, 5 and 6. In the distribution system 480 of FIG. 4, a manufacturer 482 enters into a contract to supply drugs to an organization such as a wholesale pharmacy or other pharmacy 484 that repackages the drugs into cartridges that are adapted for use in automated drug dispensing machines. This activity may require a repackager license. These cartridges may be fitted with electronic chips configured with input drug information, for example: the information required by applicable federal prescription drug labeling regulations in the USA, and the number of pills (tablets or capsules) per cartridge. The chips may also be configured to keep track of inventory as drugs are dispensed from them, and may store date and time of dispensing. Alternatively, or in addition, the system at the dispensing facility where the automated drug dispensing machine is kept may include software configured to keep track of not only prescriptions and billing, but also drug inventory in each of the multiplicity of cartridges in an automated drug dispensing machine. All this information may be stored in a software database that may be accessed locally or remotely to facilitate maintaining a high service level (i.e. low incidence of out of stock conditions). The filled cartridges are placed into an automated drug dispensing machine of the dispensing entity 486, which can then dispense drugs automatically into any of the three classes of trade 490, 492, 494 using the class-flexible system for automated drug dispensing and electronic billing, exemplified in the above description. The post-dispensing information is then available to identify the correct class of trade back to the wholesaler or manufacturer to account for any changes in class of trade in which the drug was originally allocated or sold to the dispensing party.

In an alternative exemplary embodiment of a prescription medication distribution system 500, illustrated in FIG. 5, a manufacturer 510 supplies “bulk packs” of prescription drugs to a wholesaler pharmacy 520 and/or directly to dispensing entity 530 (broken line), such as the pharmacy of a facility (e.g., hospital, LTC, etc.) that dispenses drugs to the patient directly. In the first case, the wholesaler/re-packager pharmacy 520 (who may require a re-packaging license) then repackages the bulk pack drugs into cartridges, as described for FIG. 4, for use in any dispensing entity, such as facility pharmacy 530—whether equipped with a class-flexible system for automated dispensing and electronic billing, or not. In the second case, the dispensing entity 530 receives bulk pack drugs from the wholesaler pharmacy 520, or the manufacturer 510, for filling the cartridges. The acquisition of bulk packed drugs rather than the standard 30 or 100 count bottles should reduce costs by reducing packaging, handling and labeling costs. The dispensing entity 530 can distribute drugs into the three trade classes 542, 544, 546 if it uses the class-flexible automated drug dispensing and electronic billing system. A third party entity 550 may facilitate the entire distribution system by facilitating contractual arrangements between the manufacturer 510, wholesaler/re-packager pharmacy 520 and the drug dispensing entity pharmacy 530. The third party entity 550 may be a third party beneficiary of these arrangements. The third party entity 550 may also be a direct contracting party with a series of interrelated contracts with the manufacturer 510, wholesaler/re-packager 520 and facility pharmacy 530.

In a further alternative exemplary embodiment of a prescription drug distribution system 600, illustrated in FIG. 6, the manufacturer 610 packages the drugs directly into cartridges and supplies the filled, labeled cartridges to the entity 620, such as a pharmacy or distributor. A third party entity 650 may be a wholesaler, or other type of entity. Third party entity 650 facilitates the supply of the filled cartridges for use in any drug dispensing entity 620 having automated drug dispensing machines—whether equipped with a class-flexible system for automated dispensing and electronic billing, or not. The acquisition of pre-filled cartridges directly from the manufacturer, rather the standard 30 or 100 count containers, should reduce costs by reducing re-packaging, handling and labeling costs. The drug dispensing entity 620, if equipped with a class-flexible automated drug dispensing and electronic billing system, may provide drugs in each of the three classes 662, 664, 666.

In a yet further exemplary embodiment of a prescription drug distribution system, the dispensing entities 486, 530 and 620, respectively of FIGS. 4, 5 and 6, may be an entity that operates drug dispensing kiosks (i.e. free-standing automated drug dispensing machines). These drug dispensing kiosks may be a sub class of the retail pharmacy class of trade, the LTC class, the hospital class, or may fall within an entirely new class of trade, yet to be created. Regardless, when appropriate prescription input is received, the kiosk will dispense the prescription. In order to appropriately bill the patient receiving the drugs being dispensed, the drug dispensing kiosk may communicate via the Internet or telephony, with appropriate payor entities, such as, for example, insurance companies to verify co-pay information, and with the banks to accept credit or debit card payment. Accordingly, drug dispensing kiosks will include a capability to access databases configured with the required insurance, Medicare and Medicaid billing information, as well as class of trade pricing. The kiosk interface may also be configured to receive input of the patient class of trade, if it is anticipated that users of the drug dispensing kiosk may be purchasers that fall into more than one of the classes of trade. In addition, the kiosk may communicate with the appropriate care giver to verify the prescription is valid.

Of course, the drug dispensing kiosks may be deployed by dispensing entities that do not receive drugs in bulk packs and may not receive pre-packaged cartridges, but instead fill cartridges from bottles. However, bulk pack systems and pre-filled cartridges provide cost saving advantages. Dispensing entities might therefore arrange to receive pre-filled cartridges from manufacturers, from wholesale pharmacies, from repackaging pharmacies or a third party entity that obtains drugs and is able to supply filled cartridges on demand, as cartridge inventory needs of the kiosks dictate.

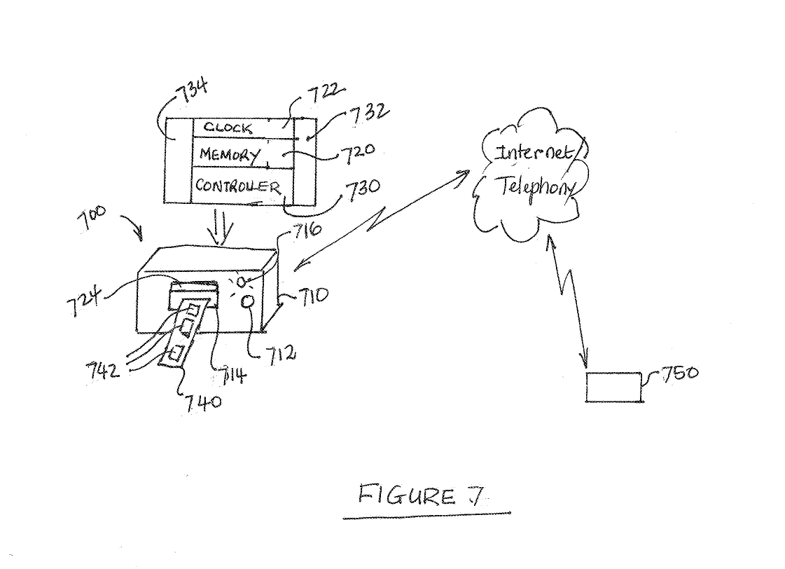

FIG. 7 is a schematic layout of an exemplary patient compliance monitor-dispenser 700. The monitor-dispenser includes a body 710 providing a housing that contains prescription medication, pre-packaged into doses to be administered at specific times, or time intervals, according to a care giver's prescription. The illustrated example of a monitor-dispenser is motorized (or manually operated) and includes a button 712 that the patient depresses at the prescribed time to cause a motor (not shown) to activate and dispense a prescribed dose from the slot 714. In the event of a failure of the patient to depress the button (or manually access a pre-packaged drug dose) within a predetermined time window after a scheduled prescription administration time, an alert 716, such as an audio visual alarm, may be triggered. In addition, the dispenser-monitor will transmit a signal, for example via the Internet or telephony, to an appropriate party 750 (e.g. a care giver or to a hospital or LTC facility) alerting that party of non-compliance. The party may respond automatically by transmitting a command or alert to the patient. For example, the party 850 may respond with, for example, an automatic return call or text message to the patient's cell phone or other device with a reminder (that might be generic for all patients or customized for the particular patient) advising that the prescription must be taken.

In the illustrated example, the monitor-dispenser 700 has memory 720 configured with software including a clock 722, a controller 730 and a microprocessor unit 734. The software is configured with the scheduled prescription administration scheduled times, and/or with time intervals after each prescription administration that fixes the next administration, as appropriate. The controller 730 controls a small optical scanner 724 that scans and reads the indicia on the prescription dose package 742 as the dose 742 on the strip 740 of the prescribed medications passes through the slot 714. The dose 742 passes through slot 714 either by the patient pulling the strip 740, or in the case of a motor-driven dispenser-monitor, through the patient pushing the button 712 and causing the motor to dispense the package 742 through the slot 714. When the indicia on the dose 742 are read by the scanner, the controller 730 commands a transmitter-receiver 732 to transmit information about compliance to the appropriate party. Compliance information may include, for example, the prescription dose and time it was taken from the monitor-dispenser, as well as any other information that it may be configured to transmit. As explained above, when a prescribed dose 742 is not scanned within a predetermined window of time after the scheduled time for administration of a prescription dose, the controller 730 commands the transmitter-receiver 732 to transmit information about non-compliance to the appropriate party for further action, and may provide an alert to the patient.

In the development of drugs or treatments, it is often useful for drug manufacturers to have access to a pool of patients having the condition that the new drug may potentially help. However, patient privacy regulations in the US, such as HIPAA, prevent drug manufacturers from obtaining such private and confidential patient-specific information from “patient information entities” that have such patient information. “Patient information entities” may include, but are not limited to, for example, hospitals, LTC facilities, patients' residences, and doctor's offices. However, these regulations do not prevent a patient information agency from data mining to determine how many patients have a particular ailment of interest to a third party, such as a drug or device manufacturer, and determining the physician or other care giver of these patients. The identity of the physician or care giver of groups of patients of interest may be provided to the third party, without violating US regulations regarding patient privacy. Accordingly, an exemplary embodiment provides the data mining of patient prescription information to create groups of patients that have a health condition in common, determining their health care provider and/or physician, and providing physician and/or other patient care giver information to interested third parties in exchange for value to the patient information entity.

While illustrative non-limiting examples of embodiments of the technology have been presented and described in text, it will be appreciated that various changes and modifications may be made in the described technology without departing from the scope of the inventions, which are set forth in, and only limited by, the scope of the appended patent claims, as properly interpreted and construed by an informed court, taking into account the doctrine of equivalents.

1. An automated class-flexible drug dispensing system, the system comprising:
an automated drug dispensing machine comprising therein a multiplicity of drug cartridges, the automated drug dispensing machine dispensing appropriate drugs on command from one or more cartridges to fill a prescription;
a user interface to input prescription information and to input class of trade information for each particular prescription to be filled;
at least one electronic storage medium having therein information comprising drug identifying information for the drug in each of the multiplicity of cartridges and for maintaining an inventory of the drug in each cartridge; and
an electronic billing system receiving the input prescription information and the input class of trade information, the billing system using the prescription information and the class of trade information to create an electronic billing entry.

2. The system of claim 1, wherein the automated drug dispensing machine is associated with a hospital pharmacy.

3. The system of claim 2, wherein the billing system is configured to apply pricing for a hospital class of trade by default.

4. The system of claim 2, further comprising an interface receiving electronically transmitted input information from a remote monitor-dispenser of a discharged patient about patient compliance with prescribed drug administration.

5. The system of claim 4, further comprising electronically and automatically transmitting information to a discharged patient in response to received input information about patient compliance with prescribed drug administration.

6. The system of claim 1, further comprising storing electronic patient health data in a database and data mining the database.

7. The system of claim 1, wherein the automated drug dispensing machine is associated with a long term care facility.

8. The system of claim 7, further comprising an interface receiving electronically transmitted input information from a remote monitor-dispenser of a resident away from the long term care facility about the compliance of the resident with prescribed drug administration.

9. The system of claim 8, further comprising electronically and automatically transmitting information to a resident away from the long term care facility in response to received input information about resident compliance with prescribed drug administration.

10. A method of automatically filling a prescription for specified medications comprising:
receiving electronic prescription information;
using the received electronic prescription information to command an automated drug dispensing machine to select and package the prescribed drugs;
electronically receiving class of trade information about the prescription;
determining a price for each drug of the prescription based on the drug and the received class of trade; and
creating an electronic billing entry.

11. The system of claim 10, wherein the automated drug dispensing machine is associated with a hospital pharmacy.

12. The system of claim 11, wherein the billing system is configured to apply pricing for a hospital class of trade by default.

13. The system of claim 11, further comprising an interface receiving electronically transmitted input information from a remote monitor-dispenser of a discharged patient about patient compliance with prescribed drug administration.

14. The system of claim 13, further comprising electronically and automatically transmitting information to a discharged patient in response to received input information about patient compliance with prescribed drug administration.

15. The system of claim 1, wherein the automated drug dispensing machine is associated with a long term care facility.

16. The system of claim 7, further comprising an interface receiving electronically transmitted input information from a remote monitor-dispenser of a resident away from the long term care facility about the compliance of the resident with prescribed drug administration.

17. The system of claim 8, further comprising electronically and automatically transmitting information to a resident away from the long term care facility in response to received input information about resident compliance with prescribed drug administration.

18. The system of claim 10, further comprising storing electronic patient health data in a database and data mining the database.

19. A business method for minimizing the cost of processing prescription drugs in a distribution system extending from a manufacturer to an end user, the method comprising:
contracting to receive prescription medications in bulk packs directly from a drug manufacturer;
arranging for repackaging of the bulk pack prescription medications into cartridges adapted for use in automated drug dispensing machines;
supplying the cartridges filled with re-packaged prescription medications to a party having control over drug dispensing machines; and
facilitating the use of the cartridges of repackaged prescription medications in a class flexible drug dispensing system linked an electronic billing system.

20. A business method for minimizing the cost of processing prescription drugs in a distribution system extending from a manufacturer to an end user, the method comprising:
contracting to receive prescription medications from a drug manufacturer in cartridges adapted for use in automated drug dispensing machines;
supplying the cartridges filled with prescription medications to a party having control over drug dispensing machines; and
facilitating the use of the cartridges of prescription medications in a class-flexible drug dispensing system linked an electronic billing system.

21. An automated class-of-trade-flexible drug dispensing system associated with a long term care facility, the system comprising:
an automated drug dispensing machine comprising therein a multiplicity of drug cartridges, the automated drug dispensing machine dispensing appropriate drugs on command from one or more cartridges to fill a prescription;
a user interface to input prescription information and to input class of trade information for each particular prescription to be filled;
an interface receiving electronically transmitted input information from a remote monitor-dispenser of a resident away from the long term care facility about the compliance of the resident with prescribed drug administration;
an electronic transmitter automatically transmitting information to a resident away from the long term care facility in response to received input information about resident compliance with prescribed drug administration;
at least one electronic storage medium having therein information comprising drug identifying information for the drug in each of the multiplicity of cartridges and for maintaining an inventory of the drug in each cartridge; and
an electronic billing system receiving the input prescription information and the input class of trade information, the billing system using the prescription information and the class of trade information to create an electronic billing entry.

22. An automated class-of-trade-flexible drug dispensing system associated with a hospital facility, the system comprising:
an automated drug dispensing machine comprising therein a multiplicity of drug cartridges, the automated drug dispensing machine dispensing appropriate drugs on command from one or more cartridges to fill a prescription;
a user interface to input prescription information and to input class of trade information for each particular prescription to be filled;
an interface receiving electronically transmitted input information from a remote monitor-dispenser of a discharged patient about patient compliance with prescribed drug administration;
a transmitter electronically and automatically transmitting information to a discharged patient in response to received input information about patient compliance with prescribed drug administration;
at least one electronic storage medium having therein information comprising drug identifying information for the drug in each of the multiplicity of cartridges and for maintaining an inventory of the drug in each cartridge; and
an electronic billing system receiving the input prescription information and the input class of trade information, the billing system using the prescription information and the class of trade information to create an electronic billing entry;
wherein the billing system is configured to apply pricing for a hospital class of trade by default.
